(19) United States
(12) Patent Application Publication
(10) Pub. No.: US 2022/0228230 A1
(43) Pub. Date: Jul. 21, 2022

(54) CLAD 2XXX-SERIES AEROSPACE PRODUCT

(71) Applicant: Aleris Rolled Products Germany GmbH, Koblenz (DE)

(72) Inventors: Bernd Jacoby, Limburg (DE); Achim Bürger, Höhr-Grenzhausen (DE); Sabine Maria Spangel, Koblenz (DE); Philippe Meyer, Koblenz (DE)

(73) Assignee: Aleris Rolled Products Germany GmbH, Koblenz (DE)

(21) Appl. No.: 17/595,490

(22) PCT Filed: May 20, 2020
(86) PCT No.: PCT/EP2020/064081

§ 371 Date: Nov. 17, 2021

(30) Foreign Application Priority Data
May 28, 2019 (EP) 19176940.5

(51) Int. Cl. C21D 8/10; C22C 21/00; C22C 21/16; C22C 21/14; C22C 21/18

(52) U.S. Cl. CPC C21D 8/10; C22C 21/00; C22C 21/18; C22C 21/14; C22C 21/16

(57) ABSTRACT

The invention relates to a rolled composite aerospace product (10) comprising a 2XXX-series core layer (20), preferably an AA2024-series aluminium alloy, and an Al—Mn alloy layer (30) coupled to at least one surface of the 2XXX-series core layer, and wherein the Al—Mn alloy layer (30) is of a 3XXX-series aluminium alloy comprising 0.3% to 2.0% Mn.

### FIELD OF THE INVENTION

The invention relates to a rolled composite aerospace product comprising a 2XXX-series core layer and an aluminium alloy layer coupled to at least one surface of the 2XXX-series core layer. The rolled composite product is ideally suitable for structural aerospace parts. The invention further relates to a method of manufacturing a rolled composite aerospace product.

### BACKGROUND OF THE INVENTION

In the aerospace industry the AA2024-series aluminium alloy and modifications thereof are widely used as a high damage tolerant aluminium alloy, mostly in a T3 condition or modifications thereof. Products of these aluminium alloys have a relatively high strength to weight ratio and exhibit good fracture toughness, good fatigue properties, and adequate corrosion resistance.

Already for many decades to enhance the corrosion resistance the AA2024-series alloy product may be provided as a composite product with on one or both sides a relative thin cladding layer. The cladding layer is usually of higher purity which corrosion protects the AA2024 core alloy. The cladding includes essentially unalloyed aluminium. Often reference is made to 1XXX-series aluminium alloys in general, and which include the sub-classes of the 1000-type, 1100-type, 1200-type and 1300-type. In practice, however, the 1XXX-series aluminium alloy used for the cladding layer is rather very pure and has a composition of, Si+Fe <0.7%, Cu<0.10%, Mn<0.05%, Mg<0.05%, Zn<0.10%, Ti<0.03%, and balance aluminium.

The AA2024-series aluminium alloy clad with a 1XXX-series alloy may also be anodized. Anodizing increases resistance to corrosion and wear and provides better adhesion for paint primers and adhesives than does bare metal. Anodized articles are applied in structural adhesive metal bonding such as in skin panels of a wing, horizontal tail plane, vertical tail plane or a fuselage. A further known application comprises a sandwich structure, wherein one or more (glass) fibre reinforced layers are interposed between aluminium panels or sheets using adhesive bonding resulting in a so-called fibre metal laminate. Patent document WO-2017/183965-A1 (Fokker) discloses a method of anodizing an aluminium alloy for applying a porous anodic oxide coating in preparation of the subsequent application of an adhesive bonding layer and/or a primer layer.

A disadvantage of the 1XXX-series alloy as clad layer is that these alloys are very soft and sensitive to surface damage during handling of the product. And also during a forming operation this may lead to for example die-sticking.

### DESCRIPTION OF THE INVENTION

As will be appreciated herein below, except as otherwise indicated, aluminium alloy and temper designations refer to the Aluminium Association designations in Aluminum Standards and Data and the Registration Records, as published by the Aluminium Association in 2018 and are well known to the persons skilled in the art. The temper designations are laid down also in European standard EN515.

For any description of alloy compositions or preferred alloy compositions, all references to percentages are by weight percent unless otherwise indicated.

The term “up to” and “up to about”, as employed herein, explicitly includes, but is not limited to, the possibility of zero weight-percent of the particular alloying component to which it refers. For example, up to 0.25% Zn may include an aluminium alloy having no Zn.

For the purpose of this invention a sheet product or a sheet material is to be understood as a rolled product having a thickness of not less than 1.3 mm (0.05 inches) and not more than 6.3 mm (0.25 inches), and plate material or a plate product is to be understood as a rolled product having a thickness of more than 6.3 mm (0.25 inches). See also Aluminium Standard and Data, the Aluminium Association, Chapter 5 Terminology, 1997.

It is an object of the invention to provide a rolled aerospace product based on a 2XXX-series alloy and offering an improved balance of corrosion resistance and formability.

This and other objects and further advantages are met or exceeded by the present invention providing a rolled composite aerospace product comprising a 2XXX-series core layer, wherein the core layer has two faces, and an Al—Mn alloy layer coupled to at least one surface or face of said 2XXX-series core layer. The Al—Mn alloy is a 3XXX-series aluminium alloy comprising 0.3% to 2.0% Mn, and preferably 0.5% to 1.8% Mn, and more preferably 0.5% to 1.5%. There are several advantages of Al—Mn alloys or 3xxx-series alloys, and of the preferred embodiments in particular, compared to 1XXX-series alloy. Al—Mn alloys or 3XXX-series alloys having up to 2.0% Mn makes the aluminium alloy more cathodic. By having at least 0.3% Mn, and preferably at least 0.5% Mn, the clad layer has a sufficient potential difference with the 2XXX-series core alloy to provide a very good corrosion resistance, in particular also a good intergranular corrosion resistance, to the rolled composite aerospace product.

Al—Mn alloys or 3XXX-series alloys have very good formability characteristics such that the rolled composite aerospace product can be formed in forming operations requiring a high degree of deformation. The formability characteristics are comparable to those of several automotive sheet aluminium alloys. The die-sticking of the clad layer to a forming die is significantly reduced or even avoided due to the increased hardness of the cladding layer compared to a 1XXX-series clad layer. The Al—Mn alloys or 3XXX-series alloys have a very good hemming performance when for example formed into a flat hem. There are no visible surface cracks after forming a flat hem. The absence of surface cracks avoids the pick-up into the surface of any forming lubricants. The absence of surface cracks also significantly increases the fatigue performance of the composite aerospace product. Also, the very good resistance against pitting corrosion improves the fatigue performance as fatigue is common triggered by pitting initiation sites. The use of Al—Mn alloys or 3XXX-series alloys avoid also the formation of Lüders-lines or stretcher strain marks during a stretching operation leading to a very good surface quality. The Al—Mn or 3XXX-series alloys have a higher strength than 1XXX-series alloys resulting in a harder surface and corresponding less surface damages like scratches during product handling.

Al—Mn alloys or 3XXX-series alloys are very good anodizable such that there are no issues with the subsequent application of an adhesive bonding layer and/or a primer layer.

Al—Mn alloys or 3XXX-series alloys are significantly stronger than 1XXX-series alloys such that the overall strength of the composite aerospace product is increased compared a 1XXX-series alloy of the same clad layer thickness. This allows also for the design of composite aerospace products having a thinner clad thickness while resulting in weight savings and still providing the required good corrosion resistance and improved formability characteristics.

Also the recycling of industrial sized scrap of the rolled composite aerospace product does not lead to any major issues as the 2XXX-series alloy has purposive additions also of Cu, Mn and Mg. Roll bonded products can be remolten without prior separation of the cladding layer(s) from the core layer.

In an embodiment the Al—Mn alloy layer or 3xxx-series aluminium alloy is bonded to the core layer by means of roll bonding, and preferably by means of hot rolling, to achieve the required metallurgical bonding between the layers. Such a roll bonding process is very economical and results in a very effective composite aerospace product presenting the desired properties. When carrying out such a roll-bonding process for producing the rolled composite product according to the invention, it is preferred that both the core layer and the 3xxx-series aluminium alloy layer(s) experience a thickness reduction during the roll bonding. The rolling bonding of a 3XXX-series aluminium alloy to the core alloy is less problematic compared to a 1XXX-series alloy which is significantly softer and requiring more rolling passes to arrive at final gauge. Typically, prior to rolling, in particular prior to hot rolling, at least the rolling faces of the core layer are scalped in order to remove segregation zones near the as-cast surface of the rolling ingot and to increase product flatness. The Al—Mn alloy clad liner can be provided as a hot rolled plate.

Preferably a cast ingot or slab of the 2XXX alloy core layer is homogenized prior to hot rolling and/or it may be preheated followed directly by hot rolling. The homogenisation and/or preheating of 2XXX-series alloys prior to hot rolling is usually carried out at a temperature in the range 400° C. to 505° C. in single or in multiple steps. In either case, the segregation of alloying elements in the material as-cast is reduced and soluble elements are dissolved. If the treatment is carried out below about 400° C., the resultant homogenisation effect is inadequate. If the temperature is above about 505° C., eutectic melting might occur resulting in undesirable pore formation. The preferred time of the this heat treatment is between 2 and 30 hours. Longer times are not normally detrimental. Homogenisation is usually performed at a temperature above about 480° C. A typical preheat temperature is in the range of about 430° C. to 460° C. with a soaking time in a range of up to about 15 hours.

In an embodiment of the invention the cast ingot or slab forming the Al—Mn alloy or 3xxx-series aluminium alloy clad liner has been homogenized prior to hot rolling to thinner gauge. The homogenisation results in a finer and more homogeneous grain structure and results in an increased formability of the Al—Mn alloy layer in the final rolled composite aerospace product. The homogenisation heat-treatment is preferably carried out at a temperature of at least 450° C. for at least about 1 hour, preferably in a range of about 1 to 30 hours, typically for about 6 to 20 hours. Preferably the homogenisation temperature is in a range of about 530° C. to 630° C.

In an embodiment of the invention the cast ingot or slab forming the Al—Mn alloy or 3xxx-series aluminium alloy clad liner has not been homogenized prior to hot rolling to thinner gauge. It has only been pre-heated to the hot rolling temperature for down-gauging to intermediate thickness for forming the hot rolled liner plate for roll bonding to the AA2XXX-series core alloy. This results in an increased corrosion resistance of the Al—Mn alloy or 3XXX-series aluminium alloy layer in the final rolled composite aerospace product.

Before hot rolling to thinner gauge to form the hot rolled liner plate for roll bonding to the AA2XXX-series core alloy, the rolling faces of the Al—Mn alloy or 3xxx-series alloy layer may be scalped in order to remove segregation zones near the as-cast surface of the rolling ingot and to increase product flatness.

The rolled composite aerospace product is down-gauged to final gauge by means of hot rolling and optionally followed by cold rolling as is regular in the art.

After the rolled composite product is rolled to final gauge the product is typically solution heat treated at a temperature in the range of about 450° C. to 505° C. for a time sufficient for solution effects to approach equilibrium, with typical soaking times in the range of 5 to 120 minutes. Preferably the solution heat-treatment is at a temperature in the range of 475° C. to 500° C., for example at about 495° C. The solution heat-treatment is typically carried out in a batch furnace or in a continuous furnace. Preferred soaking times at the indicated temperature is in the range of about 5 to 35 minutes. However, with clad products, care should be taken against too long soaking times since in particular too much copper from the 2XXX core layer may diffuse into the Al—Mn alloy or 3xxx-series aluminium alloy clad layer(s) which can detrimentally affect the corrosion protection afforded by said layer(s). After solution heat treatment, it is important that the composite product is cooled sufficiently fast to a temperature of 175° C. or lower, preferably to 100° C. or lower, and more preferably to ambient temperature, to prevent or minimize the uncontrolled precipitation of secondary phases, e. g. Al₂CuMg and Al₂Cu. On the other hand cooling rates should not be too high in order to allow for a sufficient flatness and low level of residual stresses in the composite product. Suitable cooling rates can be achieved with the use of water, e. g. water immersion or water jets. The solution heat-treatment in this temperature range results in a recrystallized microstructure of the Al—Mn alloy or 3xxx-series alloy layer. In this condition the clad layer offers an enhanced formability compared to a non-recrystallized condition.

The composite product may be further cold worked, for example, by stretching up in the range of 0.5% to 8% of its original length in order relieve residual stresses therein and to improve the flatness of the product. Preferably the stretching up is in the range of 0.5% to 6%, more preferably of 0.5% to 4% and most preferably of 0.5% to 3%.

After cooling the rolled composite aerospace product is naturally aged, typically at ambient temperatures, and alternatively the composite aerospace product can also be artificially aged. Artificial ageing during this process step can be of particular use for higher gauge products. In view of the solution heat-treatment applied the Al—Mn alloy or 3xxx-series aluminium alloy shows an enhanced solution hardening strengthening and enhanced age-hardening response, both by natural ageing and artificial ageing, leading amongst others to favourable high mechanical properties contributing to the overall strength of the final rolled composite aerospace product.

The 3XXX-series aluminium alloy layer or layers are usually much thinner than the core, each Al—Mn alloy layer constituting 1% to 20% of the total composite thickness. An Al—Mn alloy layer more preferably constitutes around 1% to 10% of the total composite thickness.

In an embodiment the 3XXX-series aluminium alloy layer is bonded on one surface or face of the 2XXX-series core layer.

In an embodiment the 3XXX-series aluminium alloy layer is bonded on both surfaces or faces of the 2XXX-series core layer forming an outer surface of the rolled composite aerospace product.

In an embodiment the rolled composite aerospace product has a total thickness of at least 0.8 mm.

In an embodiment the rolled composite aerospace product has a total thickness of at most 50.8 mm (2 inches), and preferably of at most 25.4 mm (1 inch), and most preferably of at most 12 mm.

In an embodiment the rolled composite aerospace product is a plate product.

In an embodiment the rolled composite aerospace product is a sheet product.

In an embodiment the 3XXX-series layer is from an aluminium alloy having a composition comprising, in wt. %:

| | |
|---|---|
| Mn | 0.3% to 2.0%, preferably 0.5% to 1.8%, |
| | more preferably 0.5% to 1.5%, |
| | and most preferably 0.6% to 1.25%, |
| Si | up to 1.2%, preferably ≤0.9%, more preferably ≤0.5%, |
| Fe | up to 0.7%, preferably ≤0.5%, and more preferably ≤0.3%, |
| Cu | up to 1.5%, preferably ≤1.2%, more |
| | preferably 0.20%-1.2% or ≤0.25%, |
| Mg | up to 1.0%, preferably ≤0.7%, more |
| | preferably 0.10%-0.7% or ≤0.15%, |
| Cr | up to 0.25%, preferably ≤0.15%. |
| Zr | up to 0.25%, preferably ≤0.15%, |
| Ti | up to 0.25%, preferably ≤0.2%, |
| | more preferably 0.005% to 0.20%, |
| Zn | up to 1.5%, preferably up to 1.0%, |

other elements and impurities each <0.05%, total <0.15%, and balance aluminium.

The Mn is the main alloying element and provides the strength and the formability to the clad layer. Preferably the lower limit of the Mn-content is 0.5%, and more preferably 0.6%. In an embodiment the upper limit for the Mn content is 1.8%, preferably 1.5%, and more preferably 1.25%.

In an embodiment of the 3XXX-series layer the Mg-content is in a range of 0.1% to 0.7%, and preferably in a range of 0.2% to 0.7%. The Cu-content is in a range of 0.20% to 1.2%, and preferably of 0.30% to 1.0%. With the addition of Cu the 3XXX-series alloy shows an enhanced age-hardening response after solution heat-treatment, both by natural ageing and artificial ageing, leading to favourable high mechanical properties contributing to a strength increase.

In an embodiment of the 3XXX-series layer the Mg-content is in a range of 0.1% to 0.7%, and preferably in a range of 0.2% to 0.7%. The Cu-content is in a range of up to 0.25%. While still having an age-hardening response after solution heat-treatment, the relative low Cu-content acts as a Cu-diffusion barrier for Cu from the 2xxx-series core alloy and thereby enhancing the corrosion resistance of the composite aerospace product.

In an embodiment of the 3XXX-series layer the Cu-content is in a range of 0.20% to 1.2%, and preferably in a range of 0.3% to 0.9%. The Mg-content is in a range of up to 0.25%, and preferably of up to 0.15%. Lowering the Mg content has the advantage that at the outersurface there are less Mg-based oxides adversely affecting the bonding between the core alloy layer and the clad layer. It also reduces the risk of blister formation.

In an embodiment of the 3XXX-series layer the Mg-content is up to 0.20% and the Cu-content is up to 0.25%. In a preferred embodiment the combined Mg+Cu content is less than 0.35%, and preferably less than 0.25%. This offers a good balance of formability and corrosion resistance of the rolled composite aerospace product. Lowering the Mg content has the advantage that at the outer-surface there are less Mg-based oxides adversely affecting the bonding between the core alloy layer and the clad layer. It also reduces the risk of blister formation.

In an embodiment the Fe-content is up to 0.5%, preferably up to 0.3%, and more preferably up to 0.2%. A lower Fe content is favourable for the formation of more Mn-dispersoids, in particular AlMn6 dispersoids, being the main strengthening forming element in the 3XXX-series alloy, and thereby increasing the strength of the clad layer. A lower Fe content also leads for a higher formability.

The Zn-content is up to 1.5%, and preferably up to 1%. The addition of Zn allows for the tuning of the corrosion potential required for a specific application and thereby enhancing the corrosion resistance of the rolled aerospace product.

In an embodiment the 3XXX-series layer is from an aluminium alloy having a composition consisting of, in wt. %: Mn 0.3% to 2.0%, Si up to 1.2%, Fe up to 0.7%, Cu up to 1.5%, Mg up to 1.0%, Cr up to 0.25%, Zr up to 0.25%, Ti up to 0.25%, Zn up to 1.5%, and balance aluminium and impurities, and with preferred narrower compositional ranges as herein described and claimed.

In an embodiment the composition of the 3XXX-series aluminium alloy clad layer is tuned or is set such that it has an open potential corrosion value (vs. Standard Calomel Electrode (SCE), also referred to as “corrosion potential”) of −710 mV or less (for example, −750 mV) to provide optimum corrosion protection to the 2XXX-series core alloy, and measured in a solution heat-treated and fast cooled material in a solution of 53 g/L NaCl plus 3 g/L H₂O₂ at 25° C. with a 0.1 N calomel electrode. In a preferred embodiment the corrosion potential of the 3XXX-series aluminium alloy clad layer is in a range of −730 mV to −800mV, measured after SHT and fast cooling, thus when the key alloying elements are largely in solid solution.

In an embodiment the corrosion potential difference between the 2XXX core layer and the 3XXX-series aluminium alloy clad layer, i.e. in the final temper, is in a range of 30 to 100 mV to provide sufficient corrosion protection from the anodic clad layer to the core layer.

In an embodiment the 2XXX-series core layer is from an aluminium alloy having a composition comprising, in wt. %:

| | |
|---|---|
| Cu | 1.9% to 7.0%, preferably 3.0% to 6.8%, |
| | more preferably 3.2% to 4.95%; |
| Mg | 0.30 % to 1.8%, preferably 0.35% to 1.8%; |
| Mn | up to 1.2%, preferably 0.2% to 1.2%, |
| | more preferably 0.2% to 0.9%; |
| Si | up to 0.40%, preferably up to 0.25%; |
| Fe | up to 0.40%, preferably up to 0.25%; |
| Cr | up to 0.35%, preferably up to 0.10%; |
| Zn | up to 1.0%; |
| Ti | up to 0.15%, preferably 0.01% to 0.10%; |
| Zr | up to 0.25, preferably up to 0.12%; |
| V | up to 0.25%; |
| Li | up to 2.0%; |
| Ag | up to 0.80%; |
| Ni | up to 2.5%; |

balance being aluminium and impurities. Typically, such impurities are present each <0.05%, total <0.15%.

In another embodiment the 2XXX-series core layer is from an aluminium alloy having a composition comprising, in wt. %:

| | |
|---|---|
| Cu | 1.9% to 7.0%, preferably 3.0% to 6.8%, more preferably 3.2% to 4.95%; |
| Mg | 0.30 % to 1.8%, preferably 0.8% to 1.8%; |
| Mn | up to 1.2%, preferably 0.2% to 1.2%, more preferably 0.2 to 0.9%; |
| Si | up to 0.40%, preferably up to 0.25%; |
| Fe | up to 0.40%, preferably up to 0.25%; |
| Cr | up to 0.35%, preferably up to 0.10%; |
| Zn | up to 0.4%; |
| Ti | up to 0.15%, preferably 0.01% to 0.10%; |
| Zr | up to 0.25, preferably up to 0.12%; |
| V | up to 0.25%; and |

balance being aluminium and impurities. Typically, such impurities are present each <0.05%, total <0.15%.

In preferred embodiment the 2XXX-series core layer is from an AA2X24-series aluminium alloy, wherein X is equal to 0, 1, 2, 3, 4, 5, 6, 7, or 8. A particular preferred aluminium alloy is within the range of AA2024, AA2524, and AA2624.

In an embodiment the 2XXX-series core layer is provided in a T3, T351, T39, T42, T8 or T851 condition.

The 2XXX-series core layer can be provided to a user in a non-solution heat treated condition, such as an “F” temper or an annealed “O” temper, and then formed and solution heat treated and aged by the user to the required condition, e.g. a T3, T351, T39, T42, T8 or T851 temper.

In an embodiment an interliner or inner clad layer is positioned between the outer-surface of 2XXX-series core alloy layer and the inner-surface of each Al—Mn alloy or 3XXX-series aluminium alloy layer. The interliner is made from a 3XXX-series aluminium alloy having a higher Zn-content than the 3XXX-series aluminium alloy forming the outer-surface layer of the rolled composite aerospace product. This interliner acts as a further diffusion barrier of Cu from the core alloy to the outer surface layer. The purposive higher addition of Zn also creates a Zn-gradient in the 3XXX-series layers bonded to the 2XXX-series core alloy and thereby providing increased galvanic protection to the core alloy and thereby enhancing the pitting and intergranular corrosion resistance of the core alloy by preferential interliner corrosion, while the strength and surface characteristics provided by the 3XXX-series aluminium alloy outer layer are maintained. By choosing two 3XXX-series aluminium alloy layers (interliner and outer-surface layer) instead of for example a 1XXX-series alloy interliner and a 3XXX-series outer layer, the good roll bonding characteristics of 3XXX-series aluminium alloys are maintained. There is hardly any difference in the flow behavior of the two 3XXX-series alloys having a slightly different alloy composition during a hot roll bonding operation.

In the embodiment of the 3XXX-series aluminium alloy interliner having a higher Zn-content than the 3XXX-series outer layer, the interliner has initially a lower OCP value or open potential corrosion value (vs. Standard Calomel Electrode (SCE), also referred to as “corrosion potential”) than the outer layer due to its higher Zn content. This will compensate for the Cu diffusion from the core alloy into the interliner during thermo-mechanical processing, in particular during the solution heat treatment. The Cu diffused into the interliner will raise the OCP value of the interliner back to a level of about the outer layer, which makes the two 3xxx-series layers more balanced in OCP value.

In an embodiment the thickness of each 3XXX-series alloy interliner layer is usually much thinner than the core, each interliner layer constituting 1% to 20% of the total composite thickness. An interliner layer more preferably constitutes around 1% to 10% of the total composite thickness.

In an embodiment the interliner is made from a 3XXX-series aluminium alloy comprising 0.3% to 2.0% Mn and a purposive addition of Zn in a range of 0.25% to 4%. In an embodiment the lower limit for the Zn content is 0.5%. In an embodiment the upper-limit for the Zn content is 3%.

In an embodiment the interliner is made from a 3XXX-series aluminium alloy, comprising in wt. %:

| | |
|---|---|
| Mn | 0.3% to 2.0%, preferably 0.5% to 1.8%, |
| | more preferably 0.5% to 1.5%, |
| | and most preferably 0.6% to 1.25%; |
| Zn | 0.25% to 4%, preferably 0.5% to 4%, |
| | more preferably 0.5% to 3%; |
| Si | up to 1.2%, preferably up to 0.9%, |
| | more preferably up to 0.5%; |
| Fe | up to 0.7%, preferably up to 0.5%, |
| | and more up to 0.3%; |
| Cu | up to 1.5%, preferably up to 1.2%; |
| Mg | up to 1.0%, preferably up to 0.7%; |
| Cr | up to 0.25%, preferably up to 0.15%; |
| Zr | up to 0.25%, preferably up to 0.15%; |
| Ti | up to 0.25%, preferably up to 0.2%, |
| | more preferably 0.005% to 0.20%; |

other elements and impurities each <0.05%, total <0.15%, and balance aluminium.

In an embodiment the interliner is made from a 3XXX-series aluminium alloy having a composition consisting of, in wt. %: Mn 0.3% to 2.0%, Zn 0.25% to 4%, Si up to 1.2%, Fe up to 0.7%, Cu up to 1.5%, Mg up to 1.0%, Cr up to 0.25%, Zr up to 0.25%, Ti up to 0.25%, and balance aluminium and impurities, and with preferred narrower compositional ranges as herein described and claimed.

The invention relates also to a method of manufacturing the rolled composite aerospace product of this invention, the method comprising the steps of:

(a) providing an ingot or rolling feedstock of a 2XXX-series aluminium alloy for forming the core layer of the composite aerospace product;

(b) homogenizing the ingot of said 2XXX-series aluminium alloy at a temperature in the range of 400° C. to 505° C. for at least 2 hours;

(c) providing an ingot or rolled clad liner of a 3XXX-series aluminium alloy for forming an outer clad layer on the 2XXX-series core aluminium alloy; optionally two ingots or two rolled clad liners of the 3XXX-series aluminium alloy are provided for forming a clad layer on each side of the 2XXX-series core aluminium alloy;

(d) optionally homogenizing the ingot(s) of the 3XXX-series aluminium alloy at a temperature in the range of at least 450° C. for at least 1 hour, and preferably at a temperature in a range of 530° C. to 630° C.;

(e) optionally providing an ingot or rolled clad liner of a 3xxx-series aluminium alloy for forming an interliner or inner clad layer positioned between the 2XXX-series core layer and the 3XXX-series outer clad layer; optionally providing two ingots or two rolled clad liners of the 3XXX-series aluminium alloy for forming an interliner or inner clad layer positioned between the 2XXX-series core layer and each 3XXX-series outer clad layer;

(f) roll bonding of the 3XXX-series aluminium alloy layer(s) to the 2xxx-series core alloy layer to form a roll bonded product, preferably by means of hot rolling and optionally followed by cold rolling;

(g) solution heat-treating the roll bonded product at a temperature in the range of 450° C. to 505° C., either in a batch operation or a continuous operation;

(h) cooling of the solution heat-treated roll bonded product to below 100° C., and preferably to ambient temperature;

(i) optionally stretching of the solution heat-treated roll bonded product, preferably by means of cold stretching in a range of 0.5% to 8% of its original length, preferably in a range of 0.5% to 6%, more preferably of 0.5% to 4%, and most preferably of 0.5% to 3%; and

(j) ageing of the cooled roll bonded product, by natural ageing and/or artificial ageing. In a preferred embodiment the ageing brings to 2XXX-series core layer to a T3, T351, T39, T42, T8 or T851 temper. The 3xxx-series alloy clad layers will be in an O-temper.

In an embodiment of the method according to the invention, in a next processing steps (k) the rolled composite aerospace product is formed in a forming process, at ambient temperature or at elevated temperature, into a shaped product having at least one of a uniaxial curvature or a biaxial curvature.

In an alternative embodiment of the method, after roll bonding in step (f) of the 3xxx-series aluminium alloy(s) to the 2XXX-series core alloy to form a roll bonded product, preferably by means of hot rolling and optionally followed by cold rolling, the roll bonded product is formed in a forming process, at ambient temperature or at elevated temperature, into a shaped product having at least one of a uniaxial curvature or a biaxial curvature, followed by a solution heat-treatment and subsequent ageing to a final temper.

The forming can be by a forming operation from the group of a bending operation, roll forming, stretch forming, age creep forming, deep drawing, and high-energy hydroforming, in particular by explosive forming or electrohydraulic forming.

In an embodiment the forming process or forming operation at elevated temperature is performed at a temperature in a range of about 140° C. to 200° C., and preferably the rolled composite aerospace product is kept at the forming temperature for a time in a range of about 1 to 50 hours. In a preferred embodiment the forming at elevated temperature is by means of an age creep forming operation. Age creep forming is a process or operation of restraining a component to a specific shape during ageing heat treatment, allowing the component to relieve stresses and creep to contour, for example fuselage shells with a single or double curvature.

In an embodiment it is excluded from the current invention that the rolled composite aerospace product according to this invention after having received a solutioning heat treatment (SHT) and prior to forming into a predetermined shape, the product receives a post-SHT cold working step inducing at least 25% cold work in the rolled composite aerospace product, in particular the cold working comprises cold rolling of the rolled aerospace product to final gauge, as disclosed in patent document US-2014/036699-A1 and incorporated herein by reference.

In an aspect of the invention it relates to the use of the 3XXX-series aluminium alloy as herein described and claimed as a clad layer on one or both surface of a 2XXX-series aluminium alloy to form a rolled aerospace clad product.

In a further aspect of the invention there is provided a welded structure comprising of a rolled composite aerospace product according to this invention and at least one aluminium alloy stiffening element joined to the rolled composite aerospace product by means of riveting or a welding operation.

In an embodiment the invention relates to a welded structural member of an aircraft comprising of a rolled composite aerospace product according to this invention and at least one aluminium alloy stiffening element, preferably a stringer, joined to the rolled composite aerospace product by means of riveting or a welding operation, for example by means of laser beam welding or by friction stir welding. It also relates to welded fuselage structures whereby the fuselage panels are joined to each other by means of laser beam welding (“LBW') or friction stir welding (”FSW'), e.g. by means of butt welds.

The invention also comprises an aircraft or spacecraft, the fuselage of which is wholly or partially constructed out of the rolled composite aerospace product according to this invention, which may be incorporated into various structural portions of the aircraft. For example, the various disclosed embodiments may be used to form structural portions in the wing assemblies and/or structural portions in the tail assembly (empennage). The aircraft is generally representative of commercial passenger or freight aircraft. In alternative embodiments, the present invention may also be incorporated into flight vehicles of other types. Examples of such flight vehicles included manned or unmanned military aircraft, rotary wing aircraft, or even ballistic flight vehicles.

The invention rolled composite aerospace product can be shaped into a member for an airplane, such as a fuselage component or panel, or such as a wing component or panel, and the airplane can utilize the advantage of the invention as described. The shaping referred to can include bending, stretch forming, machining and other shaping operations known in the art for shaping panels or other members for aircraft, aerospace or other vehicles. Forming involving bending or other plastic deformation can be performed at room temperature or at elevated temperatures.

### DESCRIPTION OF THE DRAWINGS

The invention shall also be described with reference to the appended drawings, in which FIGS. 1 and 2 are each a schematic diagram showing embodiments of the invention.

FIG. 1 is a schematic diagram of a rolled composite aerospace product having three distinct layers in accordance with certain illustrative embodiments.

FIG. 2 is a schematic diagram of a rolled composite aerospace product having five distinct layers in accordance with certain illustrative embodiments.

FIG. 3 is a schematic flow schedule of several embodiments of the process to manufacture a rolled composite aerospace product according to this invention.

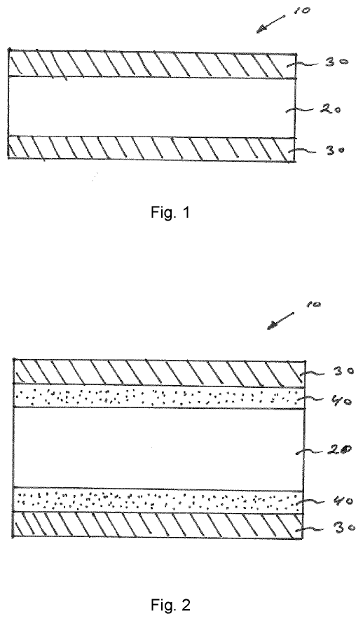

FIG. 1 illustrates the embodiment of a rolled composite aerospace product 10 having a three-layered structure of a 2XXX-series core alloy layer 20 having on each side an Al—Mn alloy clad layer 30 of a 3XXX-series aluminium alloy as herein set forth and claimed.

FIG. 2 illustrates the embodiment of a rolled composite aerospace product 10 having a five-layered structure consisting of a 2XXX-series core alloy layer 20 having on each side an Al—Mn alloy clad layer 30 of a 3XXX-series aluminium alloy as herein set forth and claimed, and wherein another Al—Mn alloy clad layer 40 is interposed between the core alloy layer 20 and the Al—Mn alloy clad layer 30 such that the Al—Mn alloy clad layer 30 forms the outer layer of the rolled composite aerospace product 10. The Al—Mn alloy clad layer 40 is also made of a 3XXX-series having a higher Zn-content than the 3XXX-series alloy of the Al—Mn alloy clad layer 30, and the Al—Mn alloy clad layer 40 has a composition as herein described and claimed.

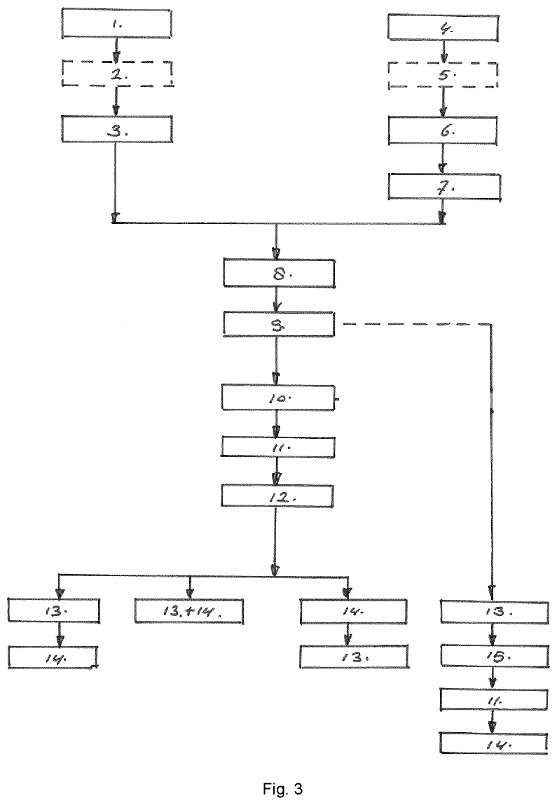

FIG. 3 is a schematic flow schedule of several embodiments of the process of this invention to manufacture a rolled composite aerospace product. In process step 1 an ingot is cast of a 2XXX-series alloy forming the core alloy of the composite aerospace product, which optionally can be scalped in step 2 to remove segregation zones near the as-cast surface of the rolling ingot and to increase product flatness. In process step 3 the rolling ingot is homogenized. In parallel in process step 4 an ingot is cast of an Al—Mn alloy or 3XXX-series aluminium alloy for forming at least one clad layer on a surface of the core alloy of the composite aerospace product, and optionally on both faces of the core alloy. Also this ingot optionally can be scalped in step 5. In process step 6 the Al—Mn alloy or 3XXX-series aluminium alloy is either homogenized and pre-heated to the hot rolling start temperature or non-homogenized and only pre-heated to the hot rolling start temperature, and subsequently in process step 7 hot rolled to form liner plate(s) as the clad layer is usually much thinner than the core. In process step 8 the 2XXX core alloy and an 3XXX-series aluminium alloy liner plate on one or both sides of the core alloy are roll bonded, preferably by means of hot rolling. Depending on the desired final gauge, the roll bonded product can be cold rolled in process step 9 to final gauge, for example to a sheet product or a thin gauge plate product. In a process step 10 the rolled aerospace product is solution heat treated, next cooled in process step 11, and preferably stretched in process step 12.

In an embodiment the cooled product is formed in forming process 13 and aged, i.e. natural or artificial ageing, in process step 14 to final temper, e.g. a T3 or T8 temper.

In an embodiment the forming process 13 and the ageing of process step 14 can be combined, for example the forming operation is performed at a temperature in a range of about 140° C. to 200° C., and preferably for a time in a range of about 1 to 50 hours, such that also artificial ageing of both the 2XXX-series core and the 3XXX-series alloy clad layer(s) occurs.

In an embodiment the cooled product is aged in process step 14, i.e. natural or artificial ageing, to a desired temper, and subsequently formed in a forming process 13 into a formed product of predetermined shape.

In an alternative embodiment after rolling bonding of the 2XXX-series core and the 3XXX-series aluminium alloy clad layer(s) to final gauge, the rolled product is formed in a forming process 13 into a predetermined shape, solution heat treated of the formed product in process step 15 and cooled in process step 11 and followed by ageing, i.e. natural or artificial ageing, in process step 14 to final temper, e.g. a T3 or T8 temper.

The invention is not limited to the embodiments described before, and which may be varied widely within the scope of the invention as defined by the appending claims.

1. A rolled composite aerospace product (10) comprising a 2XXX-series core layer (20) and an Al—Mn alloy layer (30) coupled to at least one surface of the 2XXX-series core layer and wherein the Al—Mn alloy layer (30) is of a 3XXX-series aluminium alloy comprising 0.3% to 2.0% Mn.

2. The rolled composite aerospace product according to claim 1, wherein the Al—Mn alloy layer (30) is of a 3XXX-series aluminium alloy having a composition of, in wt. %:

| | |
|---|---|
| Mn | 0.5 to 2.0, |
| Si | up to 1.2, |
| Fe | up to 0.7, |
| Cu | up to 1.5, |
| Mg | up to 1.0, |
| Cr | up to 0.25, |
| Zr | up to 0.25, |
| Ti | up to 0.25, |
| Zn | up to 1.5, |

other elements and impurities each <0.05,
total <0.15; balance aluminium.

3. The rolled composite aerospace product according to claim 2, wherein the Mg-content is in a range of 0.1% to 0.7% and the Cu-content is in a range of 0.20% to 1.2%.

4. The rolled composite aerospace product according to claim 2, wherein the Mg-content is in a range of 0.1% to 0.7% and the Cu-content is up to 0.25%.

5. The rolled composite aerospace product according to claim 2, wherein the Mg-content is up to 0.25% and Cu-content is in a range of 0.20% to 1.2%.

6. The rolled composite aerospace product according to claim 2, wherein the Mg-content is up to 0.20% and the Cu-content is up to 0.25%.

7. The rolled composite aerospace product according to claim 1, wherein the Al—Mn alloy layer (30) is non-homogenized.

8. The rolled composite aerospace product according to claim 1, wherein the Al—Mn alloy layer (30) is homogenized.

9. The rolled composite aerospace product according to claim 1, wherein the Al—Mn alloy layer (30) is coupled by means of roll bonding to the at least one surface of the 2XXX-series core layer (20).

10. The rolled composite aerospace product according to claim 1, wherein each Al—Mn alloy layer (30) has a thickness in the range of 1% to 20% of the total thickness of the rolled composite aerospace product (10).

11. The rolled composite aerospace product according to claim 1, consisting of a 2XXX-series core layer (20) and an Al—Mn alloy layer (30) coupled to one surface of the 2XXX-series core layer (20).

12. The rolled composite aerospace product according to claim 1, consisting of a 2XXX-series core layer (20) and an Al—Mn alloy layer (30) coupled to both surfaces of the 2XXX-series core layer (20).

13. The rolled composite aerospace product according to claim 1, wherein the 2XXX-series alloy of the core layer (20) has a composition of, in wt. %,

| | |
|---|---|
| Cu | 1.9% to 7.0%; |
| Mg | 0.30 % to 1.8%, |
| Mn | up to 1.2%; |
| Si | up to 0.40%; |
| Fe | up to 0.40%; |
| Cr | up to 0.35%; |
| Zn | up to 1.0%; |
| Ti | up to 0.15%; |
| Zr | up to 0.25; |
| V | up to 0.25%; |
| Li | up to 2.0%; |
| Ag | up to 0.80%; |
| Ni | up to 2.5%; and |

balance being aluminium and impurities.

14. The rolled composite aerospace product according to claim 1, wherein the 2XXX-series core layer (20) is from the 2×24-series alloy.

15. The rolled composite aerospace product according to claim 1, wherein the 2XXX-series core layer (20) is in a T3, T351, T39, T42, T8 or T851 temper.

16. The rolled composite aerospace product according to claim 1, wherein an interliner (40) is positioned between the 2XXX-series core layer (20) and the Al—Mn alloy layer (30), and wherein the interliner (40) is made from a different 3XXX-series aluminium alloy than the Al—Mn alloy layer (30), the interliner (40) being made from a 3XXX-series aluminium alloy comprising 0.3% to 2.0% Mn and 0.25% to 4% Zn.

17. The rolled composite aerospace product according to claim 1, wherein an interliner (40) is positioned between the 2XXX-series core layer (20) and the Al—Mn alloy layer (30), and wherein the interliner (40) is made from a different 3XXX-series aluminium alloy than the Al—Mn alloy layer (30), the interliner (40) being made from a 3XXX-series aluminium alloy comprising, in wt. %,

| | |
|---|---|
| Mn | 0.3% to 2.0%; |
| Zn | 0.25% to 4%; |
| Si | to 1.2%; |
| Fe | to 0.7%; |
| Cu | to 1.5%; |
| Mg | to 1.0%; |
| Cr | up to 0.25%; |
| Zr | up to 0.25%; |
| Ti | up to 0.25%; and |

other elements and impurities each <0.05%,
total <0.15%, and balance aluminium.

18. The rolled composite aerospace product according to claim 1, wherein the rolled composite aerospace product (10) has a total thickness of 0.8 mm to 50.8 mm.

19. The rolled composite aerospace product according to claim 1, wherein the rolled composite aerospace product is an aerospace structural part.

20. A method of manufacturing a rolled composite aerospace product according to claim 1, comprising the steps of:
providing an ingot of a 2xxx-series aluminium alloy for forming the core layer of the composite aerospace product;
homogenizing the ingot of the 2xxx-series aluminium alloy at a temperature in the range of 400° C. to 505° C. for at least 2 hours;
providing an ingot or rolled clad liner of a 3xxx-series aluminium alloy for forming an outer clad layer on the 2xxx-series core aluminium alloy;
optionally homogenizing the ingot of the 3xxx-series aluminium alloy at a temperature in the range of at least 450° C. for at least 1 hour;
roll bonding the 3xxx-series aluminium alloy to the 2xxx-series core alloy to form a roll bonded product, optionally followed by cold rolling;
solution heat-treating the roll bonded product at a temperature in the range of 450° C. to 505° C.;
cooling of the solution heat-treated roll bonded product to below 100° C.;
optionally stretching of the solution heat-treated and cooled roll bonded product; and
ageing of the cooled roll bonded product.

21. The method according to claim 20, wherein the method further comprises forming of the solution heat-treated and cooled roll bonded product, and optionally also being stretched, in a forming process into a predetermined shape product with a uniaxial or a biaxial curvature.

22. The method according to claim 20, wherein a forming step is performed after the ageing step.

23. The method according to claim 21, wherein the forming step and the ageing step are combined in a forming step at elevated temperature.
